(19) United States
(12) Patent Application Publication
(10) Pub. No.: US 2016/0276647 A1
(43) Pub. Date: Sep. 22, 2016

(54) BATTERY PACK

(71) Applicant: SAMSUNG SDI CO., LTD., Yongin-si (KR)

(72) Inventors: Sangjoo Lee, Yongin-si (KR); Hyungshin Kim, Yongin-si (KR)

(21) Appl. No.: 15/052,733

(22) Filed: Feb. 24, 2016

(30) Foreign Application Priority Data
Mar. 17, 2015 (KR) 10-2015-0036680

(51) Int. Cl. H01M 2/34; H01M 2/10; H01M 10/0525; H02J 7/00

(52) U.S. Cl. CPC H01M 2/34; H02J 7/0029; H01M 2/1022; H01M 10/0525; H02J 2007/0037; H02J 2007/004; H01M 2220/30

(57) ABSTRACT

A battery pack includes a battery cell having a terrace portion, a frame accommodating the battery cell, and a protection circuit module electrically connected to the battery cell and accommodated in the frame, wherein one of the frame and the protection circuit module has a protrusion portion, and the other of the frame and the protection circuit module has a fixing portion to which the protrusion portion is fixed.

### CROSS-REFERENCE TO RELATED APPLICATION

This application claims priority to and the benefit of Korean Patent Application No. 10-2015-0036680, filed on Mar. 17, 2015, in the Korean Intellectual Property Office, the entire disclosure of which is incorporated herein by reference.

### BACKGROUND

1. Field

One or more exemplary embodiments relate to battery packs.

2. Description of the Related Art

Recently, since camcorders, mobile phones, notebook computers, tablet personal computers (PCs), and the like are widely used due to the rapid development of the electronic, communication, and computer industries, lightweight, long-term-usable, high-reliability, and high-performance secondary batteries are increasingly required. According to these requirements, lithium secondary batteries are spotlighted and widely used in various fields.

Battery packs are typically used in the form of a hard pack in which a shield case is used to protect a bare cell, a safety device, or the like, or in the form of an inner pack in which a gap between a bare cell and a protection circuit board is filled with a hot-melt resin and tubing and/or labeling is performed by an exterior member.

Depending on the types of electrolytes, the lithium secondary batteries may be classified into lithium-ion batteries or lithium-metal batteries using organic solvent electrolytes and lithium-polymer batteries using solid polymer electrolytes. Also, lithium secondary batteries may be classified into cylinder-type secondary batteries, square-type secondary batteries, and pouch-type secondary batteries according to the types of cans containing electrode assemblies and electrolytes.

In general, a polymer battery using a solid polymer electrolyte is formed in the shape of a pouch, and a lithium-ion battery using an organic solvent electrolyte is formed in the shape of a cylinder or a square.

### SUMMARY

One or more exemplary embodiments include battery packs.

Additional aspects will be set forth in part in the description which follows and, in part, will be apparent from the description of the presented embodiments.

According to one or more exemplary embodiments, a battery pack includes: a battery cell including a terrace portion; a frame in which the battery cell is inserted and contained; and a protection circuit module connected electrically to the battery cell and inserted and seated in the frame, wherein one of the frame and the protection circuit module includes a protrusion portion formed to protrude outward, and the other of the frame and the protection circuit module includes a fixing portion to which the protrusion portion is fixed.

The battery pack may further include a first label portion installed to cover one surface of the battery cell and installed to cover a portion of a side surface of the frame.

The battery pack may further include a second label portion attached to the terrace portion of the battery cell.

The battery pack may further include a third label portion attached to the protection circuit module to shield the protection circuit module together with the frame.

The protection circuit module and the battery cell may be disposed on opposite sides of the frame.

The battery pack may further include a cushion portion disposed between a bottom surface of the battery cell and the frame.

The frame may include: a body portion having an internal space formed to seat the battery cell; and a seat portion formed to extend from the body portion and formed to seat the terrace portion of the battery cell on one surface thereof and seat the protection circuit module on an opposite surface thereof.

The battery pack may further include a flexible circuit board connected to the protection circuit module to electrically connect the battery pack and an external device, wherein the frame may include an extraction groove into which the flexible circuit board is inserted to be extracted outside.

The protection circuit module may include: a circuit board; and a device mounted on the circuit board and installed in a lengthwise direction of the protection circuit module to be shielded by the frame.

The battery cell may be a pouch cell.

The frame may be formed of an insulating material.

The protrusion portion may include: a first protrusion portion; and a second protrusion portion disposed to face the first protrusion portion.

The first protrusion portion and the second protrusion portion may be different in at least one of shape, size, and position.

The fixing portion may include: a first fixing portion into which the first protrusion portion is inserted; and a second fixing portion into which the second protrusion portion is inserted.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a perspective view of a battery pack according to an exemplary embodiment;

FIG. 2 is an exploded perspective view of the battery pack illustrated in FIG. 1;

FIG. 3 is a cross-sectional view taken along a line III-III of FIG. 1;

FIG. 4 is a cross-sectional view of a battery cell illustrated in FIG. 2;

FIG. 5 is a perspective view of a portion of a frame illustrated in FIG. 2; and

FIG. 6 is a diagram illustrating a process of assembling a protection circuit module and the frame illustrated in FIG. 2.

### DETAILED DESCRIPTION

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The inventive concept will be apparent from the exemplary embodiments described below in detail with reference to the accompanying drawings. The inventive concept may, however, be embodied in many different forms and should not be construed as being limited to the exemplary embodiments set forth herein; rather, these exemplary embodiments are provided so that this disclosure will be thorough and complete, and will fully convey the inventive concept to those of ordinary skill in the art. Therefore, the scope of the inventive concept is defined not by the detailed description of the exemplary embodiments but by the appended claims. The terminology used herein is for the purpose of describing the exemplary embodiments only and is not intended to be limiting of the exemplary embodiments. As used herein, the singular forms “a,” “an” and “the” are intended to include the plural forms as well, unless the context clearly indicates otherwise. It will be understood that the terms “comprise/include/have” and “comprising/including/having” used herein specify the presence of stated elements, steps, operations, or devices, but do not preclude the presence or addition of one or more other elements, steps, operations, or devices. Although terms such as “first” and “second” may be used herein to describe various elements or components, these elements or components should not be limited by these terms. These terms are only used to distinguish one element or component from another element or component.

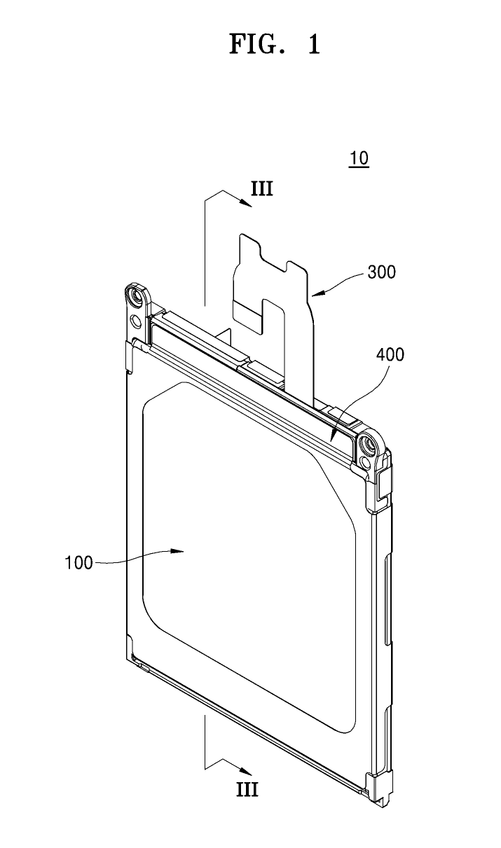

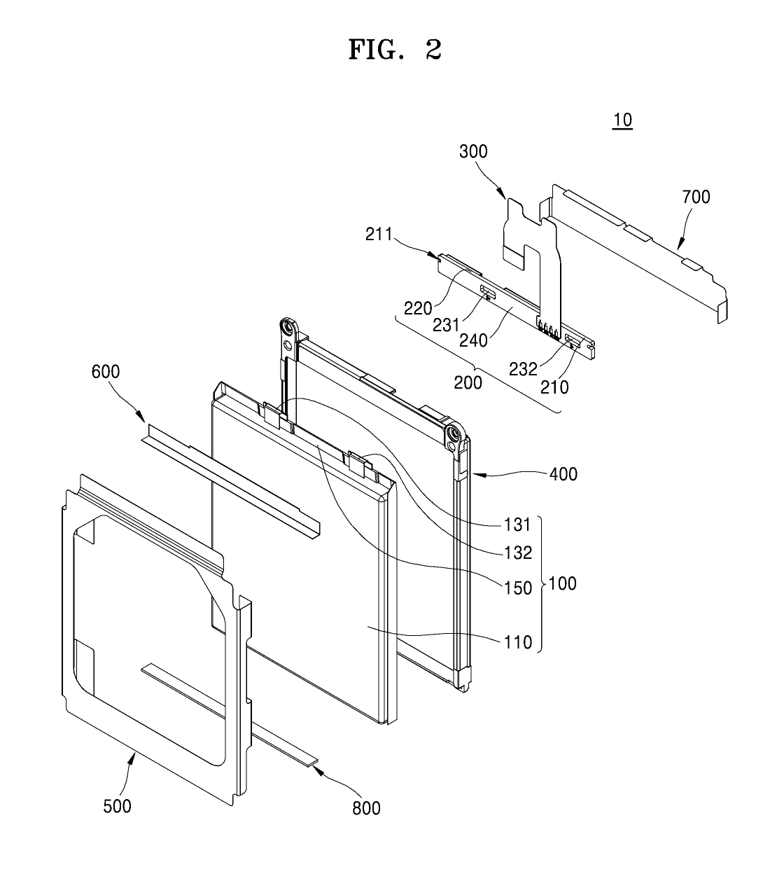

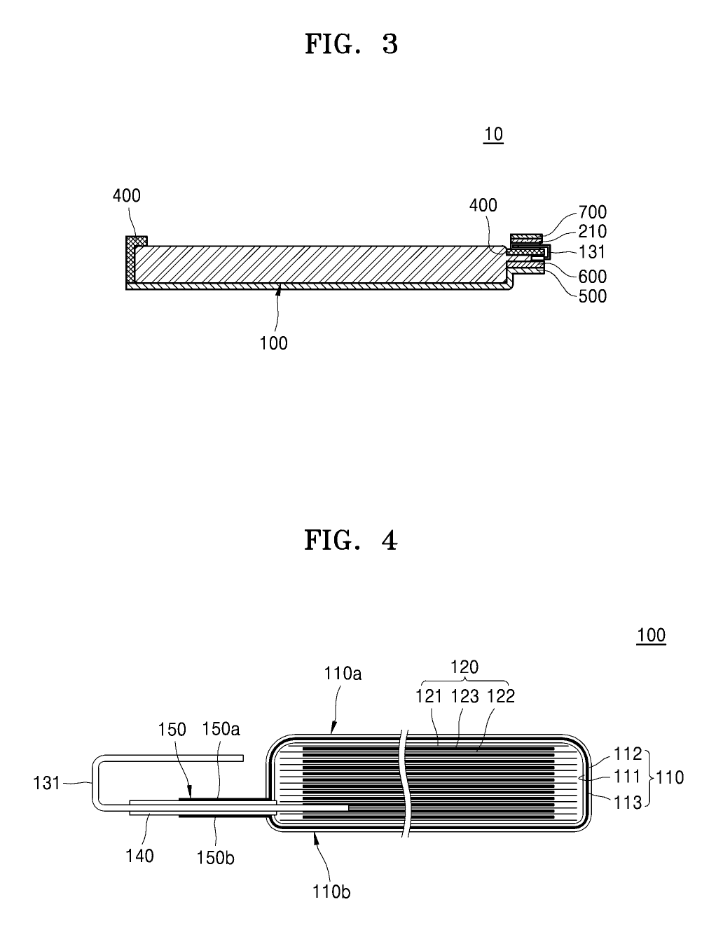

FIG. 1 is a perspective view of a battery pack 1.0 according to an exemplary embodiment. FIG. 2 is an exploded perspective view of the battery pack 10 illustrated in FIG. 1. FIG. 3 is a cross-sectional view taken along a line III-III of FIG. 1.

Referring to FIGS. 1 to 3, the battery pack 10 may include a battery cell 100, a frame 400, a protection circuit module 200, a flexible circuit board 300, a first label portion 500, a second label portion 600, a third label portion 700, and a cushion portion 800.

In one embodiment, the battery cell 100 is a pouch cell, and includes a pouch-type exterior member 110, a positive electrode tab 131, and a negative electrode tab 132 that extend from the exterior member 110. The battery cell 100 may be, for example, a lithium ion polymer battery cell. A top portion of the battery cell 100 may include a terrace portion 150, and both sides of the battery cell 100 may be bent.

The frame 400 contains the battery cell 100 and the protection circuit module 200. The frame 400 may include an insulating material being relatively rigid. For example, the frame 400 may include plastics. The rigidity of the frame 400 protects the battery cell 100 and the protection circuit module 200 from an external impact. The frame 400 will be described later in more detail.

The protection circuit module 200 is seated in or accommodated in the frame 400, and is electrically connected to the battery cell 100 to prevent the battery cell 100 from overheating or exploding due to overcharge, overdischarge, or overcurrent thereof.

The protection circuit module 200 may include a circuit board 210, a circuit device 220, a positive electrode lead tab 231, a negative electrode lead tab 232, and a safety device 240 that are mounted on the circuit board 210. The circuit device 220, the positive electrode lead tab 231, the negative electrode lead tab 232, and the safety device 240 may all be located on one side surface of the circuit board 210.

The positive electrode lead tab 231 and the negative electrode lead tab 232 are located on one side surface of the circuit board 210 to be electrically connected to the battery cell 100. The positive electrode lead tab 231 is electrically connected to the positive electrode tab 131 of the battery cell 100 by welding, and the negative electrode lead tab 232 is electrically connected to the negative electrode tab 132 of the battery cell 100 by welding.

The circuit board 210 includes a charge/discharge circuit pattern for maintaining a uniform charge state by controlling charge/discharge of the battery cell 100, or a protection circuit pattern for preventing overcharge/overdischarge thereof. The circuit device 220 installed for implementation of the charge/discharge circuit pattern and the protection circuit pattern may be located on one side surface of the circuit board 210.

When the temperature of the battery cell 100 is higher than an allowable temperature, the safety device 240 interrupts a current to prevent a malfunction caused by the heating of the battery cell 100. The safety device 240 may include a positive temperature coefficient (PTC) device.

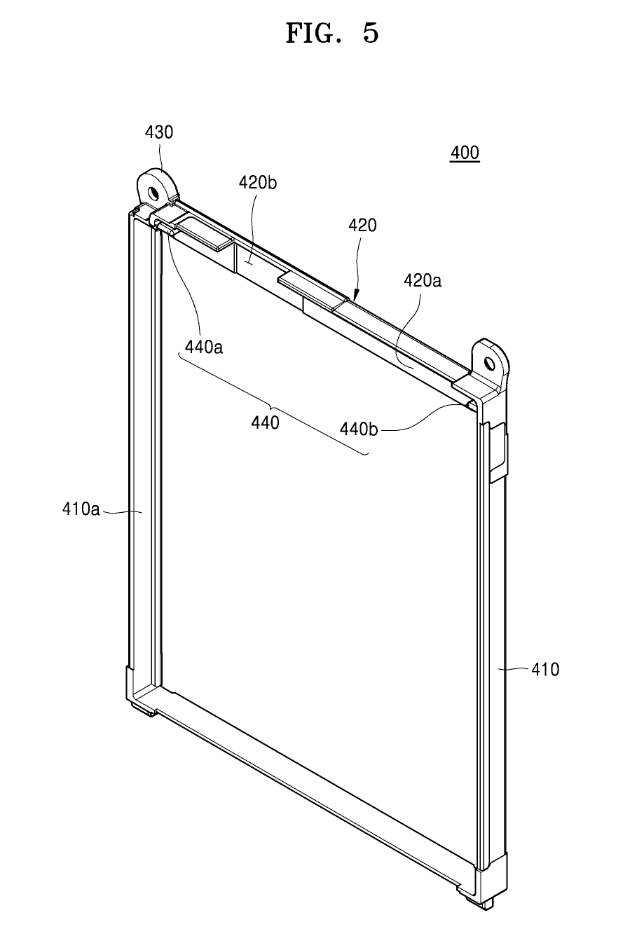

As described in more detail below with respect to FIG. 5, one of the frame 400 and the protection circuit module 200 may include a protrusion portion that is formed to protrude outward. Also, the other of the frame 400 and the protection circuit module 200 may include a fixing portion 211 into which the protrusion portion is inserted and fixed. In detail, when the frame 400 includes the protrusion portion, the protection circuit module 200 may include the fixing portion 211. On the other hand, when the frame 400 includes the fixing portion 211, the protection circuit module 200 may include the protrusion portion. However, for convenience of description, the following detailed description will focus on the case where the frame 400 includes the protrusion portion and the protection circuit module 200 includes the fixing portion 211.

The protrusion portion and the fixing portion 211 may be formed in various shapes. For example, the protrusion portion may have the shape of a simple protrusion or a ring. In this case, the fixing portion 211 may have the shape of a groove or a hole in which the protrusion portion is inserted. However, the protrusion portion and the fixing portion 211 are not limited to the above shapes or structures and may have any other shapes or structures that allow them to be connected and fixed together. For convenience of description, the following detailed description will focus on the case where the protrusion portion is formed in the shape of a protrusion and the fixing portion 211 is formed in the shape of a groove.

The flexible circuit board 300 may be connected to a positive electrode terminal connected to the positive electrode lead tab 231 and a negative electrode terminal connected to the negative electrode lead tab 232, and may be electrically connected to an external electronic device (e.g., a notebook computer, a tablet personal computer (PC), or a charger). A portion of the flexible circuit board 300 may be connected to the ground. In this case, the flexible circuit board 300 may include a connector for facilitating connection of the external electronic device.

The first label portion 500 may be oriented to face the frame 400, and may be located on an opposite side of the battery cell 100 with respect to the frame 400. In this case, the first label portion 500 may have an open center portion and a side portion that is bent to cover the frame 400 in an installation mode. In particular, the first label portion 500 may prevent the battery cell 100 from being separated from the frame 400 after being seated in the frame 400.

The first label portion 500 covers the battery cell 100 and the frame 400. After an assembly of the protection circuit module 200 and the battery cell 100 is contained into the frame 400, the first label portion 500 may be attached thereto to compact the battery pack 10 and also to protect the battery pack 10 from an external impact.

The second label portion 600 may be installed on the terrace portion 150 of the battery cell 100. In this case, the second label portion 600 may electrically insulate the terrace portion 150 from the outside to prevent the outside exposure of the portions of the positive electrode tab 131 and the negative electrode tab 132 inserted into the terrace portion 150.

The third label portion 700 may be attached to the protection circuit module 200. In this case, the third label portion 700 may be installed to cover a portion of the frame 400 to fix the protection circuit module 200 to the frame 400. For example, the third label portion 700 may be provided to cover one side surface of the protection circuit module 200, in which the circuit device 220, the positive electrode lead tab 231, the negative electrode lead tab 232, the safety device 240, and a cable are located to electrically insulate and protect the protection circuit module 200 from the outside.

Hereinafter, the battery cell 100 and the frame 400 will be described in more detail.

FIG. 4 is a cross-sectional view of the battery cell 100 illustrated in FIG. 2.

Referring to FIG. 4, the battery cell 100 includes an exterior member 110, an electrode assembly 120, and an electrolyte that are contained in the exterior member 110. The electrode assembly 120 includes a positive electrode plate 121 that is coated with a slurry for the positive electrode having a positive active material added thereto, a negative electrode plate 122 that is coated with a slurry for the negative electrode having a negative active material added thereto, and a separator 123 that is interposed between the positive electrode plate 121 and the negative electrode plate 122.

The positive electrode plate 121 may include a positive active material layer that is coated with a slurry for the positive electrode on a positive electrode current collector formed of a material such as aluminum, and a positive electrode uncoated portion that is not coated with a slurry for the positive electrode. The slurry for the positive electrode includes a positive active material. The positive active material may include, for example, a lithium chalcogenide compound or a lithium-containing transition metal oxide such as LiCoO₂, LiNiO₂, LiMnO₂, or LiMnO₄. In an exemplary embodiment, the positive electrode tab 131 is joined to the positive electrode uncoated portion, and a portion of the positive electrode tab 131 extends from the exterior member 110 to the outside.

The negative electrode plate 122 may include a negative active material layer that is coated with a slurry for the negative electrode on a negative electrode current collector formed of a material such as nickel, and a negative electrode uncoated portion that is not coated with a slurry for the negative electrode. The slurry for the negative electrode includes a negative active material. The negative active material may include, for example, a lithium alloy, a lithium metal, or a carbon material such as crystalline carbon, amorphous carbon, carbon complex, or carbon fiber. In an exemplary embodiment, the negative electrode tab 132 is joined to the negative electrode uncoated portion, and a portion of the negative electrode tab 132 extends from the exterior member 110 to the outside.

The separator 123 may include porous polypropylene (PP) or porous polyethylene (PE) so that lithium ions may move easily between the positive electrode plate 121 and the negative electrode plate 122.

The pouch-type exterior member 110 may include a metal foil 111, an insulating layer 112, and an insulating layer 113 that are formed on a top surface and a bottom surface of the metal foil 111 respectively. For example, the metal foil 111 may include a material such as aluminum or stainless steel.

A bottom surface 150b of the terrace portion 150 is substantially integrated with a bottom surface 110b of the exterior member 110, and a top surface 150a of the terrace portion 150 is provided at a lower position than a top surface 110a of the exterior member 110.

The positive electrode tab 131 and the negative electrode tab 132 may each be surrounded by an adhesive tab tape 140 to improve the sealing property with respect to the exterior member 110 and provide electrical insulation from the exterior member 110.

FIG. 5 is a perspective view of a portion of the frame 400 illustrated in FIG. 2.

Referring to FIG. 5, the frame 400 may be formed of an insulating material as described above. In this case, the frame 400 may include a body portion 410 into which the battery cell 100 is inserted, and a seat portion 420 into which the protection circuit module 200 is seated.

The body portion 410 and the seat portion 420 may be integrated with each other. In this case, a center portion of the body portion 410 may have a hole formed through. Also, a frame region of the body portion 410 may have a battery cell seat groove 410a formed to seat a frame of the battery cell 100.

The seat portion 420 may be formed to extend from the body portion 410, and a protection circuit module seat groove 420a may be formed thereat in an opposite direction with respect to the battery cell seat groove 410a of the body portion 410 to seat the protection circuit module 200.

Also, an extraction groove 420b may be formed at the seat portion 420 to extract the flexible circuit board 300 to the outside.

A protrusion portion 440 may be formed at the seat portion 420. In detail, the protrusion portion 440 may be formed at the protection circuit module seat groove 420a.

The protrusion portion 440 may include a first protrusion portion 440a and a second protrusion portion 440b that may be formed to face each other. In one embodiment, the first protrusion portion 440a and the second protrusion portion 440b may be formed, for example, on opposite side surfaces of the seat portion 420. In particular, the first protrusion portion 440a and the second protrusion portion 440b may be formed at the protection circuit module seat groove 420a to face each other.

The first protrusion portion 440a and the second protrusion portion 440b may be formed to be different from each other. In detail, the first protrusion portion 440a and the second protrusion portion 440b may be formed to be different in at least one of shape, size, and orientation.

For example, when the first protrusion portion 440a has the shape of a straight-line protrusion, the second protrusion portion 440b may have the shape of a slant-line protrusion. In another example, when the first protrusion portion 440a has a width of 12 mm, the second protrusion portion 440b may have a width of 10 mm. It will be appreciated that the present invention is not limited to the examples provided herein, but rather can be modified as understood by one of ordinary skill in the art.

In one embodiment, the first protrusion portion 440a and the second protrusion portion 440b may be formed to cross each other. For example, the first protrusion portion 440a may be formed on an upper side of the protection circuit module seat groove 420a, and the second protrusion portion 440b may be formed on a side surface of the protection circuit module seat groove 420a. In another exemplary embodiment, the first protrusion portion 440a may be located on an upper side with respect to a center line in a lengthwise direction of the seat portion 420, and the second protrusion portion 440b may be located on a lower side with respect to the center line in the lengthwise direction of the seat portion 420.

In addition, the first protrusion portion 440a and the second protrusion portion 440b may be formed at different positions and/or orientations and have different shapes and different sizes. However, for convenience of description, the following detailed description will focus on the case where the first protrusion portion 440a and the second protrusion portion 440b have different sizes.

The frame 400 may include an external device fixing portion 430 that is formed at at least one of the body portion 410 and the seat portion 420. However, for convenience of description, the following detailed description will focus on the case where the external device fixing portion 430 is formed only at the seat portion 420.

The external device fixing portion 430 may have an opening formed to accommodate a member such as a screw or a bolt thereinto. In this case, the external device fixing portion 430 may be formed symmetrically at both ends of the seat portion 420.

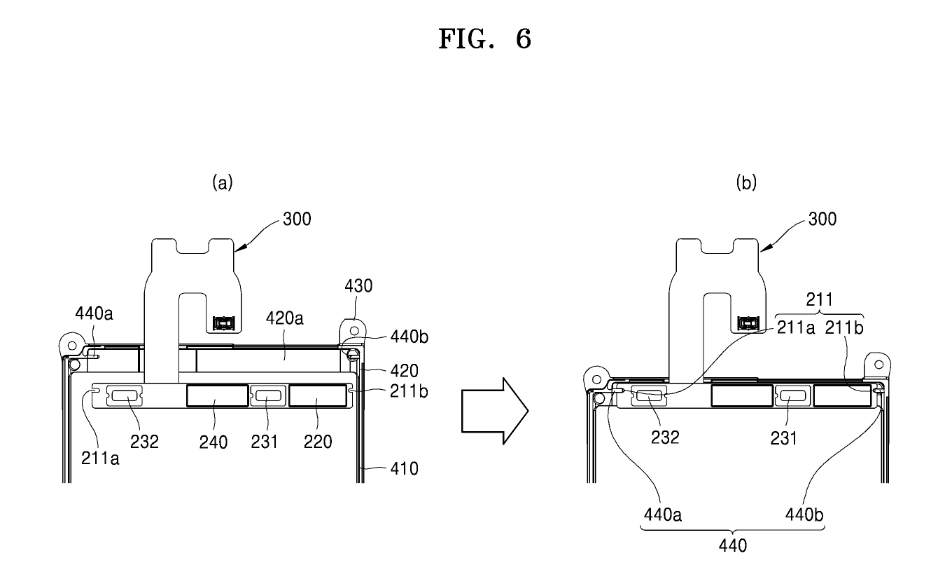

FIG. 6 is a diagram illustrating a process of assembling the protection circuit module 200 and the frame 400 illustrated in FIG. 2.

Referring to FIGS. 2 and 6, for assembly of the battery pack 10, after fabrication of the battery cell 100, and the second label portion 600 may be attached to the terrace portion 150 of the battery cell 100. Thereafter, the battery cell 100 may be inserted into the body portion 410, and then the first label portion 500 may be attached to one surface of the battery cell 100 to cover the side surface of the frame 400. In this case, the battery cell 100 may be inserted and fixed into the frame 400.

Upon completion of the above process, the positive electrode tab 131 and the negative electrode tab 132 of the battery cell 100 may be attached to the positive electrode lead tab 231 and the negative electrode lead tab 232 of the protection circuit module 200. Thereafter, the positive electrode tab 131 and the negative electrode tab 132 may be bent along the top surface of the seat portion 420, and then the protection circuit module 200 may be inserted into the seat portion 420. In this case, a portion of the flexible circuit board 300 may be exposed to the outside through the extraction groove 420b of the frame 400.

When the protection circuit module 200 is inserted into the protection circuit module seat groove 420a, the first protrusion portion 440a and the second protrusion portion 440b may be connected to the protection circuit module 200 to fix the protection circuit module 200. In detail, the fixing portion 211 may include a first fixing portion 211a and a second fixing portion 211b corresponding respectively to the first protrusion portion 440a and the second protrusion portion 440b. In this case, the first fixing portion 211a may be formed to correspond to the first protrusion portion 440a, and the second fixing portion 211 b may be formed to correspond to the second protrusion portion 440b.

Since the first protrusion portion 440a and the second protrusion portion 440b are formed differently as described above, it is less likely that the protection circuit module 200 will be assembled incorrectly. For example, if the protection circuit module 200 is inserted into the protection circuit module seat groove 420a backwards, the first protrusion portion 440a may correspond to the second fixing portion 211b and the second protrusion portion 440b may correspond to the first fixing portion 211a. In this case, the first protrusion portion 440a and the second fixing portion 211b have different sizes, and the second protrusion portion 440b and the first fixing portion 211a have different sizes. Accordingly, the first protrusion portion 440a may not be insertable into the second fixing portion 211b, or the second protrusion portion 440b may not be insertable into the first fixing portion 211a. Thus, the battery pack 10 may prevent the mis-assembly of the protection circuit module 200.

Upon completion of the disposition of the protection circuit module 200, the third label portion 700 may be attached to one surface of the protection circuit module 200 to shield the protection circuit module 200 from the outside. In this case, the third label portion 700 may face the seat portion 420 with the protection circuit module 200 therebetween, and a portion of the third label portion 700 may be installed to cover the side surface of the seat portion 420 to fix the protection circuit module 200 to the seat portion 420.

In this case, when the protection circuit module 200 is seated in the seat portion 420, at least one of the circuit device 220 and the safety device 240 mounted on the circuit board 210 may be oriented in the lengthwise direction of the seat portion 420. In particular, at least one of the circuit device 220 and the safety device 240 may be completely shielded from the outside by at least one of the seat portion 420 and the third label portion 700. Since the circuit device 220 and the safety device 240 are completely electrically insulated from the outside, a malfunction caused by an external factor may be prevented.

Thus, the battery pack 10 may be quickly installed at an accurate position of the protection circuit module 200. Also, in the battery pack 10, since the protrusion portion 440 and the fixing portion 211 are matched together, the mis-assembly of the protection circuit module 200 to the frame 400 may be prevented to minimize an error rate thereof.

Further, since the circuit device 220 and the safety device 240 of the protection circuit module 200 are completely shielded from the outside, a malfunction caused by the external moisture or the like may be minimized.

As described above, according to the one or more of the above exemplary embodiments, rapid assemblage may be implemented.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. A battery pack comprising:
a battery cell having a terrace portion;
a frame accommodating the battery cell; and
a protection circuit module electrically connected to the battery cell and accommodated in the frame,
wherein one of the frame and the protection circuit module comprises a protrusion portion, and another of the frame and the protection circuit module comprises a fixing portion to which the protrusion portion is fixed.

2. The battery pack of claim 1, further comprising a first label portion covering one surface of the battery cell and a portion of a side surface of the frame.

3. The battery pack of claim 1, further comprising a second label portion attached to the terrace portion of the battery cell.

4. The battery pack of claim 1, further comprising a third label portion attached to the protection circuit module to shield the protection circuit module together with the frame.

5. The battery pack of claim 1, wherein the protection circuit module and the battery cell are located on opposite sides of the frame.

6. The battery pack of claim 1, further comprising a cushion portion located between a bottom surface of the battery cell and the frame.

7. The battery pack of claim 1, wherein the frame comprises:
a body portion having an internal space configured to accommodate the battery cell; and
a seat portion extending from the body portion to accommodate the terrace portion of the battery cell and seat the protection circuit module on different surfaces of the seat portion.

8. The battery pack of claim 1, further comprising a flexible circuit board connected to the protection circuit module to electrically connect the battery pack and an external device,
wherein the frame comprises an extraction groove from which the flexible circuit board is extractable.

9. The battery pack of claim 1, wherein the protection circuit module comprises:
a circuit board; and
a device mounted on the circuit board and installed in a lengthwise direction of the protection circuit module to be shielded by the frame.

10. The battery pack of claim 1, wherein the battery cell is a pouch cell.

11. The battery pack of claim 1, wherein the frame comprises an insulating material.

12. The battery pack of claim 1, wherein the protrusion portion comprises:
a first protrusion portion; and
a second protrusion portion facing the first protrusion portion.

13. The battery pack of claim 12, wherein the first protrusion portion and the second protrusion portion are different in at least one of shape, size, and orientation.

14. The battery pack of claim 12, wherein the fixing portion comprises:
a first fixing portion into which the first protrusion portion is accommodated; and
a second fixing portion into which the second protrusion portion is accommodated.
